(19) United States
(12) Patent Application Publication
(10) Pub. No.: US 2019/0122196 A1
(43) Pub. Date: Apr. 25, 2019

(54) SYSTEMS AND METHODS OF OPERATING A POINT OF SALE SYSTEM

(71) Applicant: SYMBOL TECHNOLOGIES, LLC, Lincolnshire, IL (US)

(72) Inventors: Charles G. Lauria, Miller Place, NY (US); Richard J. Lavery, Huntington, NY (US); Russell Calvarese, Stony Brook, NY (US)

(21) Appl. No.: 15/792,406

(22) Filed: Oct. 24, 2017

(51) Int. Cl. G06Q 20/20

(52) U.S. Cl. CPC G06Q 20/203; G06Q 20/208

(57) ABSTRACT

Embodiments of the present disclosure relate to the field of point of sale (POS) systems, and more specifically, to reading RFID tags at or near POS transaction stations. In an embodiment, the present invention is a POS system that includes: a transaction station configured to be operated by a cashier; a cashier detector configured to detect a presence of the cashier at the transaction station; an RFID reader; and a controller operably connected to the cashier detector and to the first RFID reader, the controller being configured to operate the first RFID reader in a first mode when the cashier is detected, the controller being further configured to operate the first RFID reader in a second mode when the cashier is not detected.

### BACKGROUND

Modern retail venues often employ radio frequency identification (RFID) technologies in an effort to, among other thing, maintain an accurate accounting of their stock, assist with on-demand product replenishment, and reduce shrink events. This is typically done by affixing RFID tags to products and making an association there between that is recorded within a venue database. By tracking the RFID tags, venues are able to track products and take appropriate actions depending on where and when the RFID tags are read.

One example of relying on RFID tags to maintain proper inventory count arises in the context of checkout transactions. As consumers pick various items from store shelves and proceed through a checkout area to pay for those items, stores sometimes use RFID readers to keep track of products bought and ultimately removed from the store. This is done to maintain a more accurate inventory, which can help with maintaining an appropriate product stock. However, such systems are susceptible to false reads. For instance, a consumer with a shopping basket having various items therein may inadvertently wander near a checkout lane. The basket's proximity to the checkout lane may be close enough for the RFID reader to read the RFID tags on the products in the basket, causing a false subtraction of the products associated with the tags from the store's inventory. As a result, inventory count can be adversely effected, and thus there is a need for improved systems and methods of operating point of sale checkout systems.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an exemplary view of a venue housing a point of sale (POS) system in accordance with an embodiment of the present invention.

FIG. 2 illustrates a block diagram of an exemplary network linking at least some components of the POS system of FIG. 1.

FIG. 3 illustrates a top view of an exemplary POS transaction station.

FIG. 4 illustrates a flowchart representative of an exemplary method of operating a POS system.

FIG. 5 illustrates a flowchart representative of an exemplary method of operating a POS system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In an embodiment, the present invention is a point of sale (POS) system that includes: a transaction station configured to be operated by a cashier; a cashier detector configured to detect a presence of the cashier at the transaction station; a first radio frequency identification (RFID) reader; and a controller operably connected to the cashier detector and to the first RFID reader, the controller being configured to operate the first RFID reader in a first mode when the cashier is detected, the controller being further configured to operate the first RFID reader in a second mode when the cashier is not detected.

In another embodiment, the present invention is a method of operating a POS system having an RFID reader. The method includes: providing a transaction station configured to be operated by a cashier; detecting a presence of the cashier at the transaction station; instructing the RFID reader to operate in a first mode when the cashier is detected; and instructing the RFID reader to operate in a second mode when the cashier is not detected.

In still another embodiment, the present invention is a method of operating a POS system having an RFID reader, the POS system being in contact with a product database. The method includes: providing a transaction station configured to be operated by a cashier; detecting a presence of the cashier at the transaction station; reading, via the RFID reader, an RFID tag associated with a product; causing the reading of the RFID tag to be reflected in the product database when the cashier is detected; and causing the reading of the RFID tag to not be reflected in the product database when the cashier is not detected.

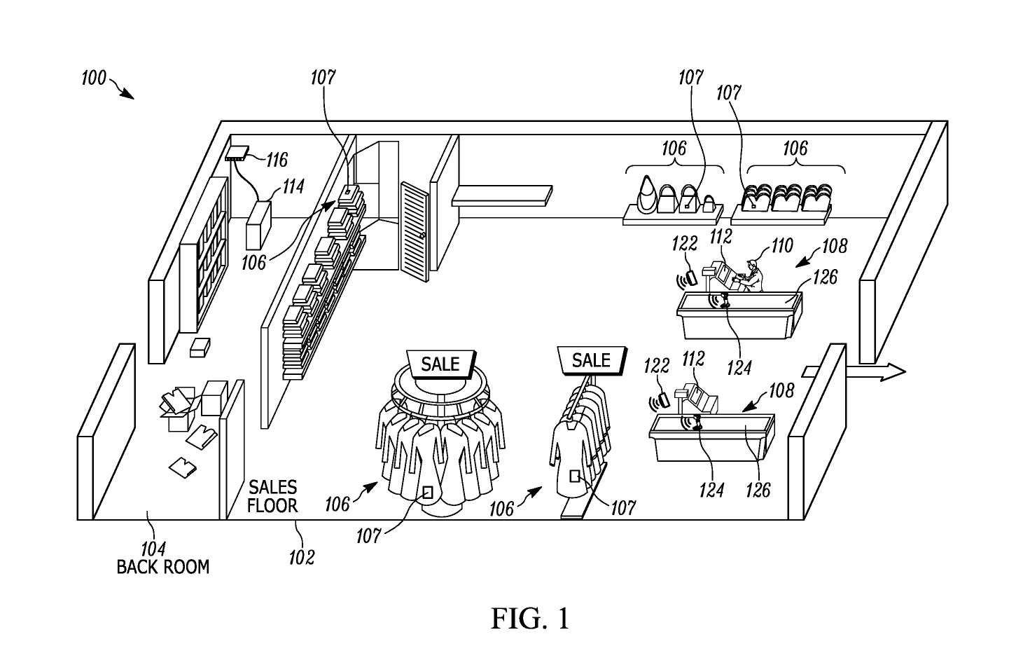

Referring now to the drawings, FIG. 1 illustrates a perspective view of an exemplary retail venue 100 for implementing POS systems in accordance with the present disclosure. The venue 100 includes a sales floor 102 and a back room 104. The sales floor 102 is typically accessible to the general public and is stocked with various products (also referred to as items or retail items) 106 positioned in an accessible manner to be picked and bought by the customers (also referred to as consumers). Preferably, each product 106 includes an RFID tag 107 that is associated with the respective product and is attached thereto in some manner (e.g., sticker, tag, etc.) Upon picking any number of products 106 of choice, customers pass through one of the POS transaction station 108 where, with the assistance of a cashier 110, they finalize their purchase of the picked products 106.

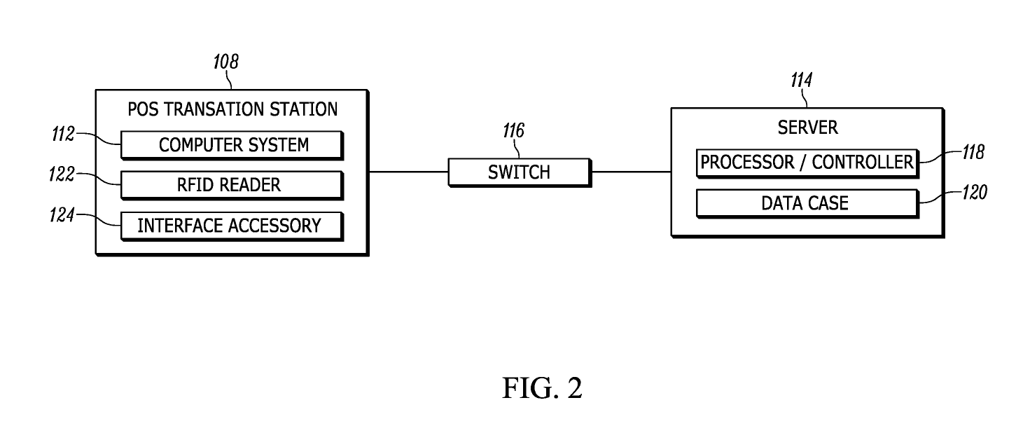

As better seen in FIG. 2, each POS transaction station 108 includes a computer system 112. Each computer systems 112 has one or more processors, and is in electronic communication with a centralized server 114 via a network switch 116 and/or via other wired, wireless, direct, or networked communication means. To maintain proper inventory, the server 114 includes at least one or more processor and/or controllers 118, and a memory having a database 120 stored therein which includes information related to items 106. While in the illustrated embodiment of FIG. 1 the server 114 is shown as being on the venue 100 premises, in other embodiments it can be partially or fully located off-site. Also, it will be appreciated that server 114 does not have to be embodied in a single enclosure, and may instead comprise a series of enclosures/computer systems configured to work together to provide enterprise-level capabilities.

The transaction station 108 also includes an RFID reader 122 and an interface accessory 124, which in some embodiments can include an optical reader configured to capture and decode a barcode, touchpad, keypad, display, and/or other data input/output accessory. The RFID reader 122 includes an RFID tag reader module that has a controller, a memory, and an RF transceiver, which are operatively connected to one or more RFID antenna elements, which are energized by the RFID module to radiate RF energy (also referred to as a beam) over an antenna beam pattern. The RFID reader 122 is operated to transmit the RF beam or wave energy to the tags, and to receive RF response signals from the tags, thereby interrogating and processing the payloads of the tags that are in a read-zone of the RF transceiver. The RFID read-zone for each RFID reader 122 may be an omnidirectional 360° zone or directional zone defined by an angle smaller than 360°. Additionally, its read-zone does not have to extend uniformly in every direction, and instead each direction may have an individually adjusted range. It should be appreciated that the 122 may be placed anywhere within the venue 100 so long as its read-zone can be adjusted to cover the appropriate area near the transaction station 108. Examples of these placements include adjacent to or near the ceiling, just above/in-line/below the transaction station 108 counter, inside the interface accessory 124, etc.

During operation, the RF transceiver may capture payload data or target data that identifies the tags and their associated products (e.g., retail items 106), and its operation can be controlled (partially or fully) by any one or more of the centralized server 114, computer system 112, or an RFID tag reader module that's part of the RFID reader.

To purchase the picked items 106, a consumer typically places the items 106 on the counter 126 for easy access by the cashier 110. The cashier 110 then proceeds to scan an identifying target that is associated with each item 106 via the interface accessory 124 and process a payment from the consumer after scanning all items. In some embodiments, the identifying target is a barcode such as, for example, a universal product code (UPC) barcode.

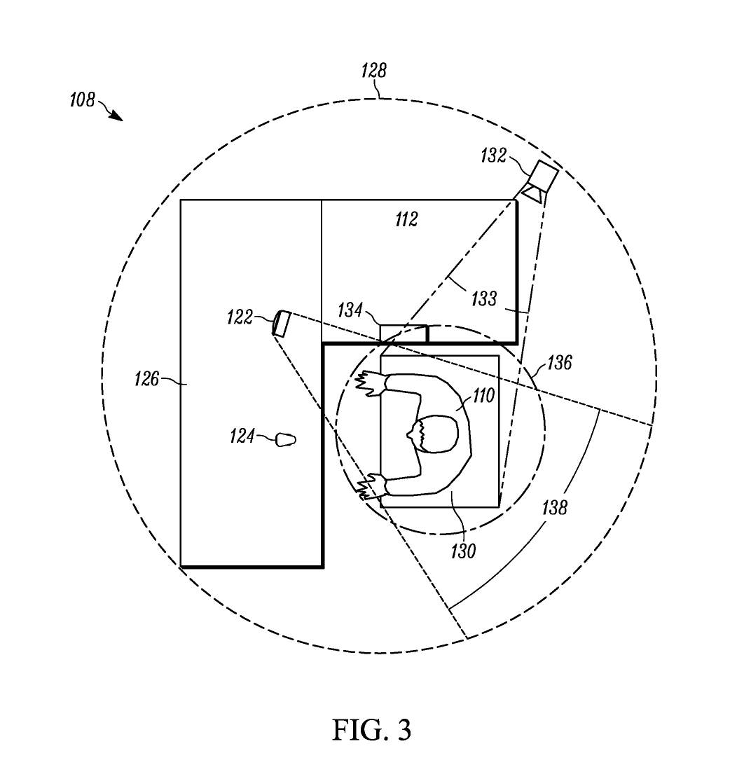

To help ensure a proper accounting of the product inventory within the venue 100, the RFID reader 122 is used in conjunction with the purchase process outlined above. As shown in FIG. 3, which illustrates a top view of the transaction station 108, an RFID reader 122 is positioned within the vicinity of the station such that its read-zone (in this case defined by the dashed circular line 128) extends at least partially over the transaction station 108, and more specifically, the area where the cashier is likely to handle the purchased items 106. The RFID reader 122 is configured to read RFID tags within its read-zone 128 and report those tags to the centralized server 114 so that a purchase of the items 106 associated with the read tags 107 can be reflected in the inventory database 120.

To help avoid reading RFID tags of items 106 that are not being purchased but happened to enter the read-zone 128, the operation of the RFID reader 122 is configured to coincide with a presence of the cashier 110. As such, the reading operation of the RFID reader 122 is modified in some way based on the detection of a presence of the cashier 110.

The presence of a cashier may be detected in any number of way. For example, the transaction station 108 can be provided with a pressure mat 130 that is placed in an area where the cashier 110 is expected to stand during a checkout transaction. Monitoring, via, for example, the centralized server 114, the pressure levels exerted on the mat, a determination of a person standing thereon can be made when the pressure indication exceeds a certain threshold.

Another mechanism for determining a presence of a cashier 110 can employ a video camera 132 having its field of view 133 directed at least partially into the area that is expected to be occupied by the cashier using a checkout transaction. A video feed from the camera 132 can be fed to the centralized server where it can be analyzed for a presence of a person in the designated cashier area. If the server 114 determines that a person is present in the specific area, a deduction can be made that it is the cashier 110.

Yet another mechanism for determining a presence of a cashier 110 includes the primary RFID reader 122 or a secondary RFID reader 134 to detect an RFID tag that is associated with an employee who is a cashier. When such a tag is detected within the read-zone of the respective RFID reader, the reading characteristics of the primary RFID reader 122 can be adjusted accordingly. In this case, it may be advantageous to use a secondary RFID reader 134 as it may have a smaller and/or a more directional read-zone 136 that particularly covers the area where the cashier 110 is expected to be during the transaction. Additionally, having two separate RFID readers can allow one to be ran at a constant setting while varying the operational characteristics of the other reader. For example, while the secondary RFID reader 134 can be operated at a full duty cycle at all times, the primary RFID reader 122 can be deactivated unless a cashier-associated RFID tag is detected by the secondary RFID reader 134. On the other hand, relying on just the primary RFID reader 122 can simplify the point of sale system, potentially leading so a less expensive, more reliable configuration. In case of using the RFID reader 122 to detect a cashier, the operation of the RFID reader itself can be varied depending on whether or not a cashier-associated RFID tag is detected. For example, the read-zone of the RFID reader 122 may be set to extend over a limited area 138 until the cashier-associated RFID tag is detected, at which point the RFID reader's 122 read-zone is adjusted to extend over the area 128. Other examples can include operating the RFID reader 122 at a relatively low duty cycle, essentially periodically pulsing the reader until a cashier-associated RFID tag is detected thereby. Once the detection occurs, the RFID reader 122 can be switched to operate at a higher (e.g., full) duty cycle.

The detection of the presence or absence of the cashier 110 is used in selecting an appropriate operation setting for the RFID reader 122 and/or how the information that is read by the RFID reader 122 is processed by, for example, the server 144. This variation of the operational characteristics may help improve inventory accuracy by reducing the number of read RFID tags that are erroneously associated with a purchased item.

In some embodiments, the RFID reader 122 remains inactive (i.e., avoids emitting a signal that would interrogate an RFID tag within its read-zone) when a cashier is not detected. This is changed when a cashier is detected in the designated location, with the RFID reader becoming active (i.e., operating in a manner sufficient to read RFID tags within its typical read-zone). In other embodiments, rather than being inactive during the times when a cashier is not detected, the RFID reader 122 is operated in a low (e.g., any range that falls below 10%) duty cycle mode. In still other embodiments, the directionality and/or the range of the read-zone of the RFID reader 122 can be altered as described earlier with reference to read-zone 138 when the cashier is not detected. In all these configuration RFID tags that appears within the vicinity of the RFID reader 122, and more particularly within its read-zone 128, will either not be read of will have a lower chance of being read when a cashier is not at the POS transaction station 108.

Another approach to reducing undesired RFID tag reads is to combine the detection of the presence or absence of a cashier with the manipulation of the data transmitted from the RFID reader 122 to the server 114. In some embodiments, network traffic from the RFID reader 122 may be blocked and/or ignored at times when the cashier is not detected. This blocking can occur at any level between and including the RFID reader 122 and the server 114, and can be achieved via any appropriate combination of hardware and software. For example, server 114 may to configured to ignore read signals from the RFID reader 122 when the cashier is not detected such that a reading of an RFID tag by the reader 122 is not reflected as a POS transaction in the product database 120. This can be changed when a cashier is detected, allowing the reads by the RFID reader 122 to be reflected as a POS transaction in the product database 120. In other examples, if the RFID reader 122 is operatively connected to the server 114 through the computer system 112, the computer system 112 can be configured to transmit an RFID read to the server 122 when the cashier is detected and it can further be configured to restrict the transmission when the cashier's absence is detected.

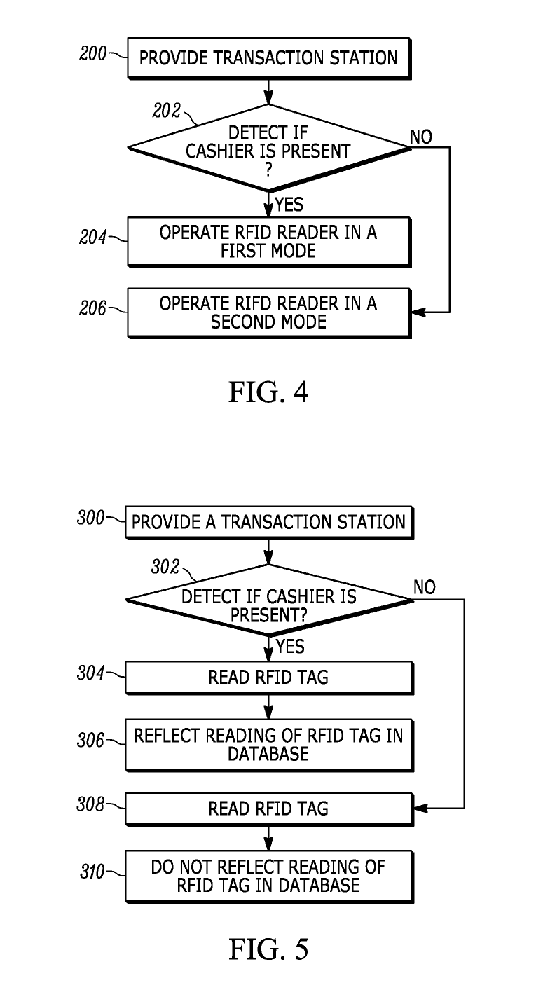

Referring now to FIG. 4, shown therein is a flowchart representative of an exemplary method of operating a POS system having an RFID reader. In step 200, there is provided a transaction station configured to be operated by a cashier. In step 202, a determination is made, by way of detecting, whether or not a cashier is present at the transaction station. If a cashier is detected, in step 204 the RFID reader is instructed to operate in a first mode (e.g., typical operating configuration that allows for RFID tags to be read such that these reads can be reflected in the product database), and if the cashier is not detected (i.e., the cashier is found to be absent), in step 206 the RFID reader is instructed to operate in a second mode (e.g., limited range, lower duty cycle, inactive, etc.).

FIG. 5 illustrates another flowchart representative of another exemplary method of operating a POS system having an RFID reader, where the POS system is in contact with a product database. In step 300, there is provided a transaction station configured to be operated by a cashier. In step 302, a determination is made, by way of detecting, whether or not a cashier is present at the transaction station. If a cashier is detected, upon reading an RFID tag in step 304, the reading of that RFID tag is caused to be reflected in the product database in step 306. Otherwise, if a cashier is not detected (i.e., the cashier is found to be absent), upon reading an RFID tag in step 308, the reading of that RFID tag is caused to be ignored in the product database in step 306.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A point of sale (POS) system comprising:
a transaction station configured to be operated by a cashier;
a cashier detector configured to detect a presence of the cashier at the transaction station;
a first radio frequency identification (RFID) reader; and
a controller operably connected to the cashier detector and to the first RFID reader, the controller being configured to operate the first RFID reader in a first mode when the cashier is detected, the controller being further configured to operate the first RFID reader in a second mode when the cashier is not detected.

2. The POS system of claim 1, wherein the cashier detector includes a pressure mat configured to be stepped on by the cashier.

3. The POS system of claim 1, wherein the controller is configured to detect, via the cashier detector, the presence of the cashier at the transaction station by detecting an RFID tag associated with the cashier.

4. The POS system of claim 3, wherein the RFID tag associated with the cashier is a part of an employee badge.

5. The POS system of claim 3, wherein the first RFID reader is further configured to read the RFID tag associated with the cashier, and
wherein the controller is further configured to detect the presence of the cashier at the transaction station by having the first RFID reader read the RFID tag associated with the cashier.

6. The POS system of claim 3, further comprising a second RFID reader configured to read the RFID tag associated with the cashier, and
wherein the controller is further configured to detect the presence of the cashier at the transaction station by having the second RFID reader read the RFID tag associated with the cashier.

7. The POS system of claim 1, wherein the first mode allows the first RFID reader to read an RFID tag associated with a product, and wherein the second mode prevents the first RFID reader from reading the RFID tag associated with the product.

8. The POS system of claim 1, wherein the first RFID reader operates at a higher duty cycle during the first mode than during the second mode.

9. A method of operating a point of sale (POS) system having a radio frequency identification (RFID) reader, comprising:
providing a transaction station configured to be operated by a cashier;
detecting a presence of the cashier at the transaction station;
instructing the RFID reader to operate in a first mode when the cashier is detected; and
instructing the RFID reader to operate in a second mode when the cashier is not detected.

10. The method of claim 9, wherein the first mode allows the RFID reader to read an RFID tag associated with a product, and wherein the second mode prevents the RFID reader from reading the RFID tag associated with the product.

11. The method of claim 9, wherein the operation of providing the transaction station includes providing a pressure mat to be stood on by the cashier, and wherein the operation of detecting the presence of the cashier includes monitoring a pressure level of the pressure mat.

12. The method of claim 9, wherein the operation of detecting the presence of the cashier includes monitoring, via the RFID reader, for a presence of an RFID tag associated with the cashier.

13. The method of claim 9, wherein the RFID reader operates at a higher duty cycle during the first mode than during the second mode.

14. A method of operating a point of sale (POS) system having a radio frequency identification (RFID) reader, the POS system being in contact with a product database, the method comprising:
providing a transaction station configured to be operated by a cashier;
detecting a presence of the cashier at the transaction station;
reading, via the RFID reader, an RFID tag associated with a product;
causing the reading of the RFID tag to be reflected in the product database when the cashier is detected; and
causing the reading of the RFID tag to not be reflected in the product database when the cashier is not detected.

15. The method of claim 14, wherein the operation of providing the transaction station includes providing a pressure mat to be stood on by the cashier, and wherein the operation of detecting the presence of the cashier includes monitoring a pressure level of the pressure mat.

16. The method of claim 14, wherein the operation of detecting the presence of the cashier includes monitoring for a presence of an RFID tag associated with the cashier.

17. The method of claim 16, wherein the operation of monitoring for the presence of the RFID tag associated with the cashier is done via at least one of the RFID reader or a second RFID reader.

18. The method of claim 14, wherein the operation of causing the reading of the RFID tag to not be reflected in the product database excludes subtracting the quantity of the product from the inventory.

19. The method of claim 18, wherein the operation of causing the reading of the RFID tag to be reflected in the product database includes subtracting a quantity of the product from an inventory in the product database.

20. The method of claim 14, wherein the operation of detecting the presence of the cashier includes monitoring, via a video camera, for a presence of a person within a designated location of the transaction station.

21. The method of claim 14, wherein the operation of causing the reading of the RFID tag to be reflected in the product database includes causing the reading of the RFID tag to be reflected as a POS transaction in the product database.
